(19) United States
(12) Patent Application Publication
(10) Pub. No.: US 2025/0060511 A1
(43) Pub. Date: Feb. 20, 2025

(54) AEROLOGICAL SONDE, SYSTEM AND METHOD FOR MEASURING METEOROLOGICAL CONDITIONS IN ATMOSPHERE

(71) Applicant: HURRICANE UNWINDER OY AB, Helsinki (FI)

(72) Inventors: Fredrik BORGSTRÖM, Helsinki (FI); Svante HENRIKSSON, Helsinki (FI); Kim KAISTI, Helsinki (FI)

(21) Appl. No.: 18/715,146

(22) PCT Filed: Nov. 30, 2022
(86) PCT No.: PCT/FI2022/050799

§ 371 Date: May 31, 2024

(30) Foreign Application Priority Data
Dec. 1, 2021 (FI) 20216235

(51) Int. Cl. G01W 1/08; G01S 19/37

(52) U.S. Cl. CPC G01W 1/08; G01S 19/37

(57) ABSTRACT

An aerological sonde, system and method for measuring meteorological conditions in atmosphere being configured to travel in the atmosphere and including a measurement unit having a navigation satellite system module arranged to receive navigation satellite system signals from navigation satellites of a global navigation satellite system as measurement data. The navigation satellite system module is configured to receive navigation satellite system signals from navigation satellites in at least two different frequencies.

### FIELD OF THE INVENTION

The present invention relates to an aerological sonde for measuring meteorological conditions in atmosphere and more particularly to an aerological sonde according to preamble of claim 1. The present invention also relates to a system for measuring meteorological conditions in atmosphere and more particularly to a system according to preamble of claim 11. The present invention further relates to a method for measuring meteorological conditions in atmosphere and more particularly to a method according to preamble of claim 17.

### BACKGROUND OF THE INVENTION

Meteorological conditions off ground in the atmosphere are conventionally measured with aerological sondes. The aerological sondes usually contain a GPS or other satellite navigation receiver, along with pressure, temperature, and humidity sensors to capture atmospheric profiles. Examples of aerological sondes are radiosondes and dropsondes. The sondes typically transmit this data to a computer by radio transmission. This helps meteorologists to record weather data at elevated heights. The data obtained is usually used as input for numerical weather prediction, enabling more accurate weather predictions.

The main shortcoming of the prior art is that aerological sondes provide measurement data which is always local at the momentary location of the sonde. They cannot measure weather parameters in their immediate or wider surroundings. Another problem associated with the prior art is that the aerological sondes are usually used only once and they may even be left in the environment when the sonde lands on ground or in the sea. Therefore, the components and battery of the sonde cause environmental harm. In order to increase the amount of data using prior art, more aerological sondes would be needed to be released to the atmosphere. This would further increase environmental harm and be costly. Another shortcoming of the prior art is that weather data from aerological sondes from different manufacturers are not objectively comparable. This is due to unknown correction and data processing formulas used to generate the output data. Further shortcomings are limited wind accuracy and resolution due to single-band global navigation satellite systems (GNSS) solutions and sonde movement unrelated to the ambient wind.

### BRIEF DESCRIPTION OF THE INVENTION

An object of the present invention is to provide an aerological sonde, a system and method for measuring meteorological conditions in the atmosphere so as to solve or at least alleviate the prior art disadvantages.

The objects of the invention are achieved by an aerological sonde which is characterized by what is stated in the independent claim 1. The objects of the invention are also achieved by a system which is characterized by what is stated in the independent claim 11. The objects of the invention are further achieved by a method which is characterized by what is stated in the independent claim 17.

The preferred embodiments of the invention are disclosed in the dependent claims.

The invention is based on the idea of providing an aerological sonde for measuring meteorological conditions in atmosphere, the aerological sonde being configured to travel in the atmosphere and comprising a measurement unit having a navigation satellite system module arranged to receive navigation satellite system signals from global navigation satellites of a navigation satellite system as measurement data. According to the present invention the navigation satellite system module is configured to receive navigation satellite system signals from navigation satellites of the navigation satellite system in at least two different frequencies.

Receiving in the aerological sonde the navigation satellite system signals having two different frequencies from one navigation satellite enables calculating tropospheric delay by utilizing the navigation satellite system signals having two different frequencies. The tropospheric delay may be further utilized for calculating amount of water vapor or humidity in the atmosphere. This so called wet delay is larger than variations in the delay caused by temperature and pressure variations. However, the tropospheric delay may be yet further utilized for calculating also temperature and pressure in the atmosphere when enough data is present.

The dual-band GNSS solution is particularly helpful for calculating the ionospheric delay, which is typically clearly larger than the tropospheric delay. When the ionospheric delay is known, the typically smaller tropospheric delay is easier to calculate.

The ionospheric and the tropospheric delay measurements are based on tracking and measuring the carrier phases of the GNSS signals at two or more frequencies. The typically larger ionospheric delay is calculated by using the GNSS signals at two or more frequencies and the remaining, typically smaller, tropospheric delay may then be calculated by using effectively one single frequency of the GNSS signals. It is also possible to calculate the tropospheric delay using more than one frequency of the GNSS signals.

By combining a large number of such recorded GNSS signals from different sondes launched from different sites, the gathered data can be combined in algorithms calculating humidity, temperature and pressure data for very large parts of the troposphere.

There are many well-known alternative atmospheric models created that describe the propagation of radio signals and that may be used in relating tropospheric delays to temperature, pressure, humidity and water vapor distributions in the atmosphere. Typically, such a calculation involves an inversion-type calculation, where complex sets of equations are solved for what the atmospheric composition has to be based on the observed signal delays at all of the sondes for the locations where the sondes have been. Using the data obtained by the invention, any end-user can thus apply well-known methods to calculate humidity, temperature and pressure for a large number of points far from where any of the locations visited by any of the sondes involved. It is also typical for such an atmospheric model to comprise both tropospheric and ionospheric parts. The ionospheric part may be a simple model, whereby the ionospheric delay is simply calculated using the difference in propagation of the GNSS signals at two or more frequencies from each navigation satellite, or it may contain a more detailed description of the ionosphere. The tropospheric model is often based on a numerical weather prediction or other computational atmospheric model.

In some embodiments, the navigation satellite system module comprises a first navigation satellite system receiver configured to receive navigation satellite system signals having a first frequency from the navigation satellites of the navigation satellite system, and a second navigation satellite system receiver configured to receive navigation satellite system signals having a second frequency.

Therefore, the aerological sonde comprises two navigation satellite system receivers are arranged to receive navigation satellite system signals having two different frequencies.

In another embodiment, the aerological sonde comprises a dual-frequency navigation satellite system receiver configured to receive navigation satellite system signals having a first frequency from the navigation satellites of the navigation satellite system, and navigation satellite system signals having a second frequency from the navigation satellites of the navigation satellite system.

The dual-frequency navigation satellite system receiver is arranged to receive navigation satellite system signals from the navigation satellites of the navigation satellite system, having two different frequencies with only one receiver component.

In some embodiments, the navigation satellite system module comprises a third navigation satellite system receiver configured to receive navigation satellite system signals having a third frequency from the navigation satellites of the navigation satellite system.

Thus, the aerological sonde comprises three navigation satellite system receivers are arranged to receive navigation satellite system signals having three different frequencies from the navigation satellites of the navigation satellite system.

It should be noted that is defined the navigation satellite system receivers are configured to receive navigation satellite system signals from the navigation satellites of the same or one navigation satellite system.

In a further embodiment, the aerological sonde comprises a multi-frequency navigation satellite system receiver configured to receive navigation satellite system signals having three or more, or multiple, different frequencies from the navigation satellites of the navigation satellite system.

In some embodiments, the aerological sonde comprises the dual-frequency navigation satellite system receiver or the multi-frequency navigation satellite system receiver configured to measure carrier phase data based on the two or more different frequencies.

Accordingly, the dual-frequency navigation satellite system receiver or the multi-frequency navigation satellite system receiver is configured measure carrier phase data by measuring phase difference between the two or more received frequencies. This further enables eliminating ionospheric in in the navigation satellite system signal, and thus facilitate calculations of tropospheric delay.

In some embodiments, the navigation satellite system module is configured to receive navigation satellite system signals from two or more navigation satellites of the navigation satellite system simultaneously.

In some alternative embodiments, the navigation satellite system module is configured to receive navigation satellite system signals from two or more navigation satellites of two or more different navigation satellite systems.

Accordingly, the navigation satellite system module is configured to receive navigation satellite system signals on at least two different frequencies from the navigation satellites of each of the two or more different navigation satellite systems.

Receiving navigation satellite system signals from two or more navigation satellites and satellite systems simultaneously and by utilizing the at least two different frequencies enable calculating the amount of water vapor or humidity in the atmosphere in multiple directions from the aerological sonde. Thus, three-dimensional water vapor concentration or humidity content in the atmosphere may be calculated. Furthermore, given enough data, also temperature and pressure variations in the three-dimensional atmosphere can be calculated.

In some embodiments, the navigation satellite system module is configured to receive navigation satellite signals from one or more of the following:
the navigation satellite system is a global navigation satellite system, the navigation satellite system module is configured to receive global navigation satellite system signals;
the navigation satellite system is a regional navigation satellite system, the navigation satellite system module is configured to receive regional navigation satellite system signals;
the navigation satellite system is a GPS, the navigation satellite system module is configured to receive GPS signals; or
the navigation satellite system is a Glonass system, the navigation satellite system module is configured to receive Glonass system signals;
the navigation satellite system is a BeiDou system, the navigation satellite system module is configured to receive BeiDou system signals;
the navigation satellite system is a Galileo system, the navigation satellite system module (39) is configured to receive Galileo system signals;
the navigation satellite system is a QZSS system, the navigation satellite system module is configured to receive QZSS system signals; and
the navigation satellite system is stationary navigation satellite system, the navigation satellite system module is configured to receive stationary navigation satellite system signals.

Stationary navigation satellite systems comprise for example SBAS, WAAS, EGNOS and MSAS systems.

In some embodiments, the global navigation satellite system module is configured to receive GPS signals, the GPS signals having at least two of frequency bands L1, L2 and L5.

In some other embodiments, the global navigation satellite system module is configured to receive Glonass system signals, the Glonass system signals having at least two of frequency bands G1, G2 and G3.

In some further embodiments, the global navigation satellite system module is configured to receive Galileo system signals, the Galileo system signals having at least two of frequency bands E1, E5a, E5b and E6.

In further embodiments, the global navigation satellite system module is configured to receive frequency bands L1, L2 and L5.

In some other embodiments, the global navigation satellite system module is configured to receive Glonass system signals, the Glonass system signals having at least two of frequency bands G1, G2, G3, E1, E5a, E5b, E6, L1, L2 and L5.

In some other embodiments, the navigation satellite system module is configured to receive QZSS system signals, the QZSS system signals having at least two frequency bands L1 and L5.

In some embodiments, the aerological sonde is a radiosonde comprising an ascent member arranged to lift the radiosonde in the atmosphere.

The radiosonde may receive global navigation satellite system signals during ascent and/or descent of the radiosonde.

In some other embodiments, the aerological sonde is a dropsonde comprising a parachute member arranged to slow down the descent of the dropsonde in the atmosphere.

The dropsonde may receive global navigation satellite system signals during descent or dropping of the radiosonde.

In some further embodiments, the aerological sonde comprises a sonde casing, the sonde casing is arranged to form a sole drag surface of the aerological sonde such that a self-sustaining aerological sonde is formed.

The self-sustaining aerological sonde may receive global navigation satellite system signals during travel or migration in the atmosphere.

In some embodiments, the measurement unit of the aerological sonde comprises a turbulence sensor arranged to measure turbulence in the atmosphere.

In some other embodiments, the measurement unit of the aerological sonde comprises a turbulence sensor arranged to measure turbulence in the atmosphere, the turbulence sensor comprising a gyroscopic sensor arranged to measure change of orientation of the aerological sonde.

In some further embodiments, the measurement unit of the aerological sonde comprises a turbulence sensor arranged to measure turbulence in the atmosphere, the turbulence sensor comprising an accelerometer arranged to measure change of rate of velocity of the self-sustaining aerological sonde.

In some yet further embodiments, the measurement unit of the aerological sonde comprises a turbulence sensor arranged to measure turbulence in the atmosphere, the turbulence sensor comprising a gyroscopic sensor arranged to measure change of orientation of the aerological sonde and an accelerometer arranged to measure change of rate of velocity of the self-sustaining aerological sonde.

In addition, or instead of the accelerometer and the gyroscopic sensor, the turbulence sensor may also comprise a magnetometer.

The turbulence sensor enables measuring turbulence and vorticity data and may be used to improve the accuracy of the navigation satellite signals received in the aerological sonde, through correction calculations, and also calculations carried out based on the global navigation satellite signals received in the aerological sonde.

In some embodiments, the measurement unit comprises one or more light sensors.

By light sensor shall be meant an electro-optical sensor that converts light rays into electric signals that can then be read by an instrument to measure the intensity and/or spectra of the incoming light. Also, multiple electro-optical sensors combined shall be understood as a light sensor. Light is here broadly defined to comprise also the infrared and ultraviolet parts of the electromagnetic spectrum in addition to visible light. Different light sensors have different sensitivities to given parts of the electromagnetic spectrum. Some are more sensitive in the infrared, while others are more sensitive in the visible or ultraviolet parts. The effective sensitivity and spectrum of a light sensor can be changed by adding an optical filter on it on the side of the sensing element, where light enters. An electro-optical sensor with such an optical filter added shall also be understood as a light sensor in this invention. By a multispectral light sensor shall be meant a sensor that converts light from different parts of the electromagnetic spectrum into separate electric signals that can all separately by read by one or more instruments to deduct the light intensity in different parts of the spectrum. The multispectral property may be achieved by having multiple electro-optical sensors with different sensitivity spectra, or by adding optical filters with different filtering spectra. The optical filters may be added on one or multiple electro-optical sensors.

In some embodiments, the light sensor is a photodiode or a combination of multiple photodiodes.

In some embodiments, the light sensor is multispectral.

In some embodiments, the light sensor comprises optical filters to detect different parts of the electromagnetic spectrum through filtering them through to the photodiodes.

The photodiodes and optical filters of the light sensor may have peaks in the infrared, optical and/or ultraviolet parts of the electromagnetic spectrum.

A light sensor is always placed outside the sonde casing or its sensing element protrudes outside the sonde casing.

The advantages of a light sensor are many-fold. Firstly, in prior art aerological sondes, temperature and humidity measurements by temperature and humidity sensors on the sonde have to be corrected for solar and infrared radiation. The corrections are not exact, but based on variables such as solar elevation angle, geographical location etc. They do not take into account the details of the radiation actually experienced by the sensor. With a light sensor, the corrections can be made based on actual measurement data. Furthermore, raw data can be stored for technical and scientific analysis such as comparison between sondes, further technical development and so on. Secondly, the light sensor gives readings of electromagnetic radiation in different directions from the sonde. These data can be used in models calculating cloud optical thicknesses for different wavelengths, water vapor, liquid water, frozen water (ice), temperature, pressure and other atmospheric variables.

In some embodiments, the measurement unit comprises a telemetry module configured to transmit measurement data from the aerological sonde.

In some other embodiments, the measurement unit comprises a telemetry module, the telemetry module comprising a wireless transmitter element configured to transmit measurement data from the aerological sonde.

In some further embodiments, the measurement unit comprises a telemetry module, the telemetry module comprising an FM transmitter element configured to transmit measurement data from the aerological sonde.

In some yet further embodiments, the measurement unit comprises a telemetry module, the telemetry module comprising a wireless communication network element configured to transmit measurement data from the aerological sonde.

The wireless transmitter element may any known wireless transmitter element or wireless communication network element of a communication network, such as 2G, 3G, 5G and beyond, or LAN (local area network), Wi-Fi, low-power wide-area networks (such as LoRa, Sigfox, NB-IoT) or the like.

In some embodiments, the aerological sonde of the measurement unit thereof is provided with a memory, such as a memory card or memory chip. The measurement unit is arranged to store measurement data to the memory.

The present invention is also based on an idea of providing a system for measuring meteorological conditions in atmosphere. The system comprises one or more aerological sondes, the one or more aerological sondes being configured to travel in the atmosphere and comprising a measurement unit having a navigation satellite system module arranged to receive navigation satellite system signals from navigation satellites of a navigation satellite system as measurement data and a telemetry module configured to transmit measurement data from the aerological sonde. The system further comprises at least one base station, the at last one base station comprising a communication module configured to receive the measurement data from the one or more aerological sondes.

According to the present invention the navigation satellite system module of the one or more aerological sondes is configured to receive navigation satellite system signals from navigation satellites of the navigation satellite system in at least two different frequencies.

Receiving the navigation satellite system signals from each satellite in two different frequencies enables calculating delays and thus enhancing the accuracy of the position measurements by calculating errors based on the delays. Utilizing the at least two different frequencies of the navigation satellite system signals enable calculating the delay.

Water vapour and condensed water and ice in the form of clouds causes delay in the navigation satellite system signals in troposphere. Temperature and pressure variations also cause variations to the delay, typically smaller. Therefore, the delay in the troposphere, and to a smaller extent in the lower stratosphere, depends on weather conditions. Accordingly, utilizing the at least two different frequencies of the navigation satellite system signals enable calculating meteorological conditions in the atmosphere by utilizing the two different frequencies of the navigation satellite system signals. Thus, the amount of water vapor or condensed water may be calculated. Temperature and pressure may also be calculated. Thus, the atmospheric meteorological conditions may be calculated based on the navigation satellite system signals.

In some embodiments, the navigation satellite system module comprises a first navigation satellite system receiver configured to receive navigation satellite system signals having a first frequency from the navigation satellites of the navigation satellite system, and a second navigation satellite system receiver configured to receive navigation satellite system signals having a second frequency from the navigation satellites of the navigation satellite system.

In some other embodiments, the navigation satellite system module comprises a dual-frequency navigation satellite system receiver configured to receive navigation satellite system signals having a first frequency and navigation satellite system signals having a second frequency from the navigation satellites of the navigation satellite system.

In some further embodiments, the navigation satellite system module comprises a multi-frequency navigation satellite system receiver configured to receive navigation satellite system signals having different frequencies from the navigation satellites of the navigation satellite system.

In some embodiments, the telemetry module comprises a wireless transmitter element configured to transmit measurement data from the aerological sonde.

In some other embodiments, the telemetry module comprises an FM transmitter element configured to transmit measurement data from the aerological sonde.

FM transmitter enables sending measurement data in FM frequencies.

In some further embodiments, the telemetry module comprises a wireless communication network element configured to transmit measurement data from the aerological sonde.

The wireless communication network element enables providing connection to wireless communication networks for transferring measurement data.

In some embodiments, the base station comprises one or more of the following:
the communication module of the base station comprises at least one base station navigation satellite system receiver configured to receive navigation satellite system signals from navigation satellites of the navigation satellite system,
the communication module of the base station comprises an FM receiver configured to receive measurement data from the one or more aerological sondes, and
the communication module of the base station comprises a wireless communication network element to receive measurement data of the one or more aerological sondes.

In some embodiments, the system comprises a processing unit configured to calculate humidity in the atmosphere by utilizing the at least two different frequencies of the received navigation satellite system signals. In some other embodiments, the system comprises a processing unit configured to calculate temperature and/or pressure in the atmosphere by utilizing the at least two different frequencies of the received navigation satellite system signals. Accordingly, the at least two different frequencies of the received navigation satellite system signals received form the satellites enable determining signal delay and further the amount of water vapor or condensed water in the atmosphere. Furthermore, temperature and pressure in the atmosphere may also be determined based on the received navigation satellite system signals having at least two different frequencies. Water vapor, liquid water and ice typically cause larger delay effects than temperature and pressure, for which reason only humidity, water vapor, liquid water and ice are calculated approximately in some embodiments.

In some embodiments, the system comprises one or more aerological sondes as described above.

The present invention is further based on the idea of providing a method for measuring meteorological conditions in atmosphere—The method comprises releasing an aerological sonde to the atmosphere and allowing the aerological sonde to travel in the atmosphere and receiving in the aerological sonde navigation satellite system signals from navigation satellites of a navigation satellite system, as measurement data during the travel of the aerological sonde in the atmosphere.

According to the present invention the method comprises receiving navigation satellite system signals from navigation satellites of the navigation satellite system, during the travel of the aerological sonde in the atmosphere on least two different frequencies.

In some embodiments, the method comprises receiving at least two navigation satellite system signals from two or more navigation satellites of the navigation satellite system simultaneously, respectively, and the at least two navigation satellite system signals having different frequencies.

In some other embodiments, the method comprises receiving at least two navigation satellite system signals from two or more navigation satellites of two or more different navigation satellite systems, respectively, and the at least two navigation satellite system signals having different frequencies.

Accordingly signal delays may be calculated to different directions from the aerological sonde. Signal delays may be calculated in the directions between the aerological sonde and the respective satellites. Therefore, further the amount of water vapor, liquid water or ice in the atmosphere may be calculated in the directions between the aerological sonde and the respective satellites. Therefore, water vapor, liquid water, ice or humidity may be calculated from the aerological sonde towards different satellites.

In some embodiments, the aerological sonde is a radiosonde comprising an ascent member arranged to lift the radiosonde in the atmosphere, and the method comprises receiving the navigation satellite system signals of the navigation satellite system, during ascent of the radiosonde or during descent of the radiosonde or during ascent and descent of the radiosonde in the atmosphere.

Accordingly, momentary signal delays may be calculated in the directions between the aerological sonde and the respective satellites during the ascent and/or descent of the radiosonde. Therefore, further amount water vapor or condensed water in the atmosphere may be calculated in the directions between the aerological sonde and the respective satellites during the ascent and/or descent of the radiosonde. Accordingly, this allows calculating three-dimensional water vapor or humidity profile in the atmosphere during descent of the radiosonde and/or during ascent and descent of the radiosonde in the atmosphere.

In some other embodiments, the aerological sonde is a dropsonde comprising a parachute member arranged to slow down dropping of the dropsonde in the atmosphere, and the method comprises receiving the navigation satellite system signals of the navigation satellite system, during descent of the dropsonde in the atmosphere.

Accordingly, momentary signal delays may be calculated in the directions between the dropsonde and the respective satellites during the descent of the dropsonde. Therefore, further amount water vapor or condensed water in the atmosphere may be calculated in the directions between the dropsonde and the respective satellites during the descent. Accordingly, this allows calculating three-dimensional water vapor or humidity profile in the atmosphere during descent of the dropsonde in the atmosphere.

In some embodiments, the aerological sonde is an aerological sonde comprising a sonde casing, the sonde casing is arranged to form a sole drag surface of the aerological sonde such that a self-sustaining aerological sonde is formed, and the method comprises receiving the navigation satellite system signals of the navigation satellite system, during the travel of the aerological sonde in the atmosphere.

Accordingly, momentary signal delays may be calculated in the directions between the self-sustaining aerological sonde and the respective satellites during the migration of the dropsonde. Therefore, further amount water vapor or condensed water in the atmosphere may be calculated in the directions between the self-sustaining aerological sonde and the respective satellites during the migration in the atmosphere. Accordingly, this allows calculating three-dimensional water vapor or humidity profile in the atmosphere during migration or travel of the self-sustaining aerological sonde in the atmosphere.

In some embodiments, the method further comprises calculating tropospheric delay or wet component of the tropospheric delay of the navigation satellite system signals of the navigation satellite system received in the aerological sonde by utilizing the navigation satellite system signals having the at least two different frequencies.

In some other embodiments, the method further comprises calculating humidity in the atmosphere by utilizing navigation satellite system signals of the navigation satellite system, having the at least two different frequencies.

In some further embodiments, the method further comprises calculating temperature in the atmosphere by utilizing the navigation satellite system signals of the navigation satellite system, having the at least two different frequencies.

In some other embodiments, the method further comprises calculating humidity and temperature in the atmosphere by utilizing the navigation satellite system signals of the navigation satellite system, having the at least two different frequencies.

In some further embodiments, the method comprises calculating a three-dimensional humidity model of the atmosphere by utilizing the at least two frequencies of the received navigation satellite system signals from the two or more navigation satellites of the navigation satellite system, during the travel of the aerological sonde in the atmosphere.

In some yet further embodiments, the method comprises an inversion calculation of a three-dimensional atmospheric model for navigation satellite signals comprising a tropospheric part with humidity, temperature and pressure fields and an ionospheric part comprising a description of the ionosphere by utilizing the at least two frequencies of the received navigation satellite system signals from the two or more navigation satellites of the navigation satellite system, during the travel of the aerological sonde in the atmosphere.

The method of the present invention may be carried out with a system as described above or with an aerological sonde as described above.

By receiving two or more navigation satellite system signals from one or each satellite of the navigation satellite system, in different frequencies enables determining the amount of humidity in the atmosphere by calculating and utilizing the signal delays in the atmosphere. Therefore, the humidity sensor may be omitted in the aerological sonde and the aerological sonde may be provided simpler and the weight of the sonde may be decreased. Omitting the humidity sensor also decreases power consumption in the sonde and thus a smaller battery may be provided to the sonde. This further decreases the weight of the aerological sonde. Furthermore, utilizing two or more navigation satellite system signals from one or each satellite of the navigation satellite system, in different frequencies during the travel of the aerological sonde in the atmosphere enables calculating a three-dimensional humidity distribution of the atmosphere. Another benefit of the obtained data is a possibility to objectively evaluate the output humidity data of other aerological sondes. The GNSS signal delays are independent of possible humidity sensors used.

### BRIEF DESCRIPTION OF THE DRAWINGS

The invention is described in detail by means of specific embodiments with reference to the enclosed drawings, in which

FIG. 1 schematically shows measuring meteorological conditions in atmosphere with an aerological sonde;

FIGS. 2 to 4 show schematically different kinds of aerological sondes;

FIG. 5 shows schematically a measuring unit of an aerological sonde;

FIG. 6 shows schematically a system according to the present invention; and

FIGS. 7 to 10 show schematically different embodiments of according to the present invention.

### DETAILED DESCRIPTION OF THE INVENTION

In the context of this application, the aerological sonde 1, and all the parts and components thereof, means an aerological sonde that is designed to move, float, ascend, descend or migrate in the atmosphere.

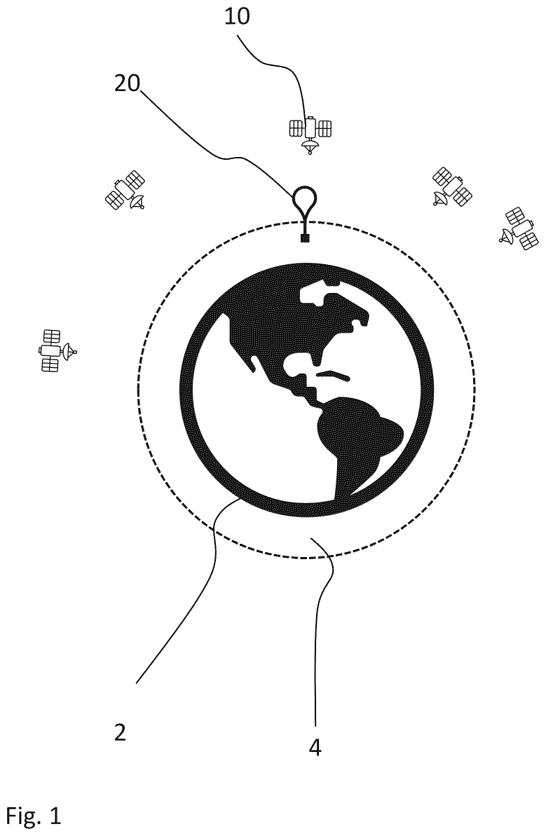

FIG. 1 shows schematically earth 2 and the atmosphere surrounding the earth 2. The atmosphere comprises the troposphere 4. The troposphere is the lowest layer of the atmosphere of the earth 2. Most of the weather phenomena occur in the troposphere 4.

In the following embodiments of the invention are disclosed in relation to global navigation satellite systems, but the invention may also be similarly utilized with regional or stationary navigation satellite systems or with combination with global navigation satellites systems.

FIG. 1 further shows global navigation satellites 10 orbiting around the earth 2. The FIG. 1 also shows schematically an aerological sonde 20 which travels in the atmosphere and measures meteorological conditions of the atmosphere. The aerological sondes 20 comprise a global navigation satellite system module arranged to receive global navigation satellite system signals from the global navigation satellites of a global navigation satellite system as measurement data for defining location of the aerogical sondes during the travel of the aerological sonde 20 in the atmosphere.

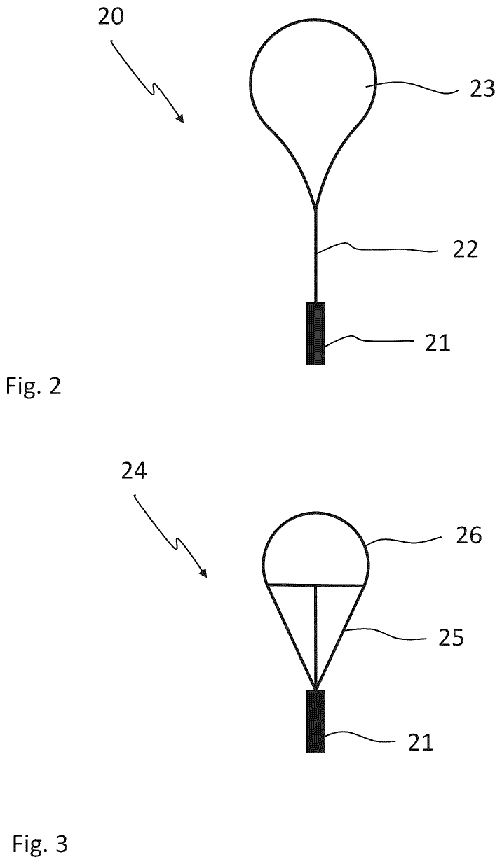

FIG. 2 shows one type of an aerological sonde which is radiosonde 20. The radiosonde 20 comprises a sonde member 21 and a balloon 23 attached to the sonde member 21 with an attachment member 22, as shown in FIG. 2. The balloon 23 is filled with gas lighter than air such that the radiosonde lifts upwards when released from the sea or ground surface. The balloon 23 controls the ascent and stabilizes the radiosonde 20. Some radiosondes 20 are anchored to ground in such a way that they remain at a certain height. The sonde member 21 comprises a sonde casing to protect electronics and form a more stable aerodynamic profile. The balloon 23 is attached to the sonde casing via a suspension cord 22. A measurement unit of the radiosonde 20 is provided to the sonde member 21, preferably inside the sonde casing.

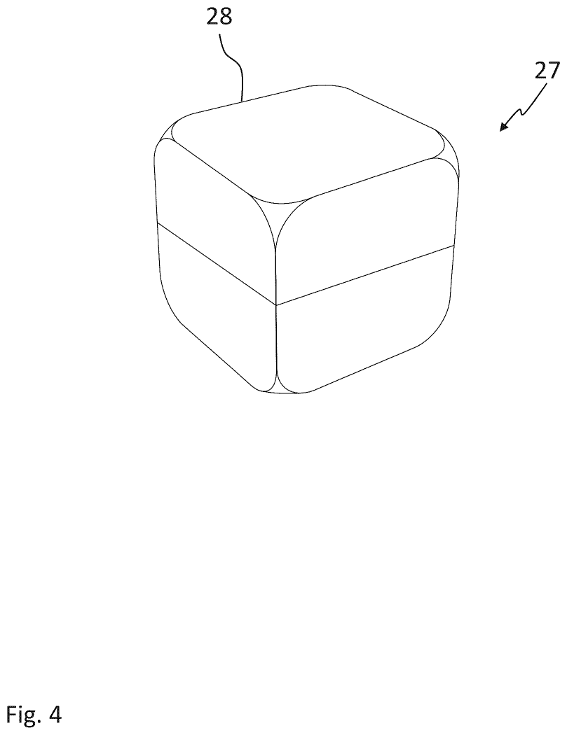

FIG. 3 shows another type of aerological sonde which is dropsonde 24. The dropsonde 24 comprises a sonde member 21 and a parachute 26 attached to the sonde member 21 with an attachment member 25, as shown in FIG. 3. The dropsonde 24 is dropped from an aircraft, balloon, UAV, drone or other airborne vehicle to measure atmospheric conditions or storm conditions as the sonde member falls to the ground surface. The dropsonde 24 descent is slowed and stabilized by the parachute 26, allowing for more readings or measurements to be taken before it reaches the ocean surface or ground surface. The parachute 26 is designed to immediately deploy after release of the dropsonde 24 for reducing or eliminating any pendulum movements. The dropsonde 24 typically drops for three to fifteen minutes before reaching the ocean or ground surface. The sonde member 21 comprises a sonde casing to protect electronics and form a more stable aerodynamic profile. The parachute 26 is attached to the sonde member 21 via a suspension cord 25. The parachute may also be directly attached to the sonde member. A measurement unit of the dropsonde 24 is provided to the sonde member 21, preferably inside the sonde casing.

FIG. 4 shows a further type of aerological sonde which is a self-sustaining aerological sonde 27. The self-sustaining aerological sonde 27 comprises on the sonde member forming the stream sonde 27. The self-sustaining aerological sonde 27 comprises a sonde casing 28 and a measurement unit is provided inside the sonde casing 28. In some embodiments, parts of the measurement unit may protrude outside the self-sustaining aerological sonde and the sonde casing 28. The sonde casing 28 itself also has protrusions in some embodiments. The sonde casing 28 comprises casing walls having an outer surface and this outer surface of the sonde casing also forms the outer surface of the self-sustaining aerological sonde 27. Therefore, the outer surface of the sonde casing 28 alone, along with possibly protruding measurement unit elements or intentionally added protrusion, defines the outer shape of the self-sustaining aerological sonde 27. Thus, the sonde casing 28 and the outer surface of the sonde casing 28, and possible additional protrusions, are arranged to define sole drag surface self-sustaining aerological sonde 27. Thus, a self-sustaining aerological sonde is provided.

In the embodiment of FIG. 4, the self-sustaining aerological sonde 27 and the outer surface of the sonde casing 28 provides a cubic shape. Accordingly, the self-sustaining aerological sonde 27 of FIG. 4 has cubic outer shape. Further, the corners of the cubic shape are rounded such that the self-sustaining aerological sonde 27 has rounded cubic shape. However, the sonde casing may have any geometric shape in other embodiments.

The sonde casing 28 comprises casing walls which defines a hollow sonde space inside the sonde casing 28. A measurement unit and measurement components are provided and installed inside the sonde casing 28 and into the sonde space.

The self-sustaining aerological sonde 27 of FIG. 4 has a drag surface which is formed solely by the outer surface of the sonde casing 28. Thus, a self-sustaining aerological sonde is formed. The self-sustaining aerological sonde 27 has a preferred terminal velocity equal to or less than 7 m/s, or 5 m/s, or preferably equal to or less than 4 m/s, or more preferably equal to or less than 3 m/s in standard atmospheric conditions. However, a self-sustaining aerological sonde may also have a higher terminal velocity. As disclosed above, the terminal velocity of the self-sustaining aerological sonde 27 is determined by the outer casing surface of the sonde casing 28, or the shape of the self-sustaining aerological sonde 27, and the weight of the self-sustaining aerological sonde 27. When for example a cyclonic storm comprises a vertical wind component or storm which is equal or greater than the terminal velocity of the self-sustaining aerological sonde 27, the self-sustaining aerological sonde 27 maintains its altitude or lifts upwards. In cyclonic storms, there are at times vertical wind components on the order of 3 m/s or greater. Also, in tornados such vertical wind components and much greater ones occur. Therefore, the self-sustaining aerological sonde 27 may float or migrate in a cyclonic storm or tornado and along with the storm for prolonged time periods and considerable distances.

In order to achieve the above mentioned terminal velocity, total weight of the self-sustaining aerological sonde 27 needs to be restricted in relation to the projected area of the sonde casing 28. Increasing the size of the self-sustaining aerological sonde 27 would decrease the terminal velocity, but at the same time the weight of the self-sustaining aerological sonde 27 would be increased due to the enlarged sonde casing 28. Therefore, in order to achieve the above disclosed terminal velocity, the total weight of the self-sustaining aerological sonde 27 is preferably equal to or less than 20 g, or 15 g, or 10 g, or preferably equal to or less than 8 g, or more preferably less than 6 g. When the total weight of the self-sustaining aerological sonde 27 is substantially 10 g or less, the size of the self-sustaining aerological sonde 27 and the sonde casing 28 may be kept rather small and the above disclosed terminal velocity may be still achieved.

The aerological sondes 20, 24, 27 are provided with measurement units 12 comprising the measurement sensors, battery and other components for carrying out the measurements. The sensors and components are provided to a circuit board 30.

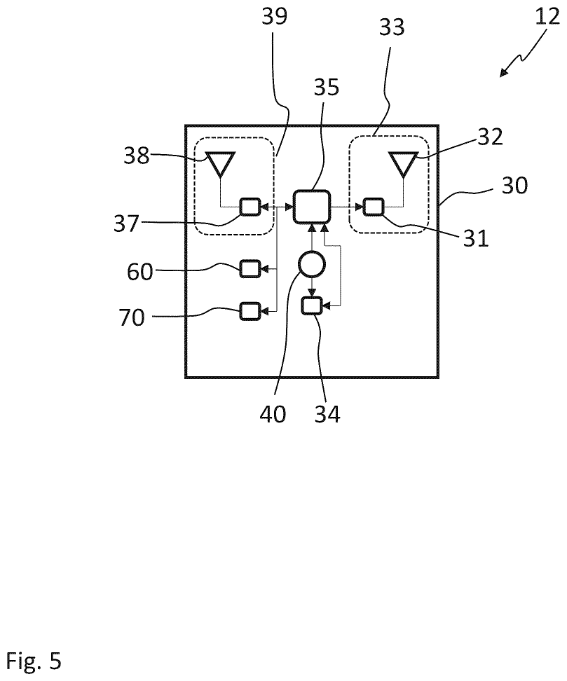

FIG. 5 shows one embodiment of the measurement unit 12 of the aerological sonde 20, 24, 27.

The measurement unit comprises a power source 40 which provides electrical power to the measurement unit 12 and components thereof.

In some embodiments, the battery 40 is a Lithium-Polymer battery or a semi-solid Lithium metal battery or a foam battery with porous copper structure.

The measurement unit 12 further comprises power management circuitry 34 connected to the battery 40 and a microcontroller 35. The power management circuitry 34 controls power usage of the measurement unit 12 and components thereof.

In preferred embodiments, the measurement unit 12 comprises a meteorological sensor 60 or meteorological measurement element 60 comprising at least one of the pressure sensor, the humidity sensor, and the temperature sensor in one component.

The meteorological measurement element 60 may also comprise at least two of the pressure sensor, the humidity sensor, and the temperature sensor as separate components. In some embodiments, the humidity sensor is omitted.

In some embodiments of the present invention, both the humidity and temperature sensors are omitted.

In some further embodiments, the humidity, temperature and pressure sensors are omitted.

In some embodiments, the measurement unit 12 or the meteorological measurement element 60 further comprises a magnetometer. The magnetometer is arranged to measure changes in the magnetic field measured by the sonde, for example caused by sonde rotation or by weather systems such as thunders. The magnetometer may be any known kind of magnetometer, preferably a very light-weight magnetometer.

The measurement unit 12 further comprises a global navigation satellite system module 39 is configured to receive global navigation satellite system signals from global navigation satellites 10.

In the present invention, the global navigation satellite system module 39 is configured to receive global navigation satellite system signals from global navigation satellites 10 in at least two different frequencies.

Accordingly, the global navigation satellite system module 39 comprises a first global navigation satellite system receiver 37 and global navigation satellite system antenna 38 configured to receive global navigation satellite system signals in at least two different frequencies.

Thus, the global navigation satellite system module 39 comprises a first global navigation satellite system receiver 37 configured to receive global navigation satellite system signals having a first frequency and a second global navigation satellite system receiver 37 configured to receive global navigation satellite system signals having a second frequency.

Alternatively, the global navigation satellite system module 39 comprises a dual-frequency global navigation satellite system receiver 37 configured to receive global navigation satellite system signals having a first frequency and global navigation satellite system signals having a second frequency.

Further alternatively, the global navigation satellite system module 39 comprises a multi-frequency global navigation satellite system receiver 37 configured to receive global navigation satellite system signals 100 having different frequencies.

The global navigation satellite system receiver 37 comprises a global positioning system (GPS) receiver. Alternatively, global navigation satellite system receiver 37 comprises a GPS, Galileo, Beidou and/or Glonass receiver.

A high-quality, well-selected antenna may be important to obtain a high enough signal-to-noise ratio for the processing unit mentioned earlier to obtain accurate information about humidity, water vapor, condensed water, ice, and possibly, temperature and pressure variations.

In some embodiments, the global navigation satellite system antenna 38 is provided as a circularly polarized antenna.

In some embodiments, the global navigation satellite system antenna 38 is provided as linearly polarized antenna.

In some embodiments, the global navigation satellite system antenna 38 is provided to the circuit board 30 or to the flexible circuit board 30 as a circuit board antenna.

In some embodiments, the global navigation satellite system antenna 38 is provided to the circuit board 30 or to the flexible circuit board 30 as a patch antenna.

The patch antenna has the benefits of stronger directivity and gain, which is helpful for obtaining a good signal-to-noise ratio.

In case the global navigation system antenna is a patch antenna, it may take the form of a stacked dual-element patch or single-element patched antenna in some embodiments. The patch antenna may have single, dual or multiple feeds for the two or more frequencies received.

In some embodiments, the global navigation satellite system antenna 38 is provided to the circuit board 30 or to the flexible circuit board 30 as a helical antenna.

Alternatively, the global navigation satellite system antenna 38 is provided to the circuit board 30 or to the flexible circuit board 30 as a linearly polarized chip antenna. This may also be a circuit board antenna.

The circuit board antenna or chip antenna 38 may be linearly polarized antennas.

The circuit board antenna or chip antenna 38 is preferable due to their light-weight structure of these types of antennas.

Thus, the global navigation satellite system module 39 is configured to measure location of the aerological sonde 20, 24, 27 in the atmosphere by receiving the global navigation satellite system signals.

In some embodiments, the measurement unit 12 further comprises a barometer (not shown) or altimeter arranged to measure altitude of the aerological sonde 20, 24, 27 during meteorological measurements. The barometer or altimeter is arranged to measure the altitude via atmospheric pressure measurements. The barometer or altimeter is preferably provided to the circuit board 30 and connected to the microcontroller 35.

The barometer or altimeter may be form example a micro electromechanical systems, or MEMS, barometer or altimeter.

In some embodiments, the measurement unit 12 of the sonde member 10 comprises a turbulence sensor 70 arranged to measure turbulence in the atmosphere or in the cyclonic storm.

In one embodiment, the turbulence sensor 70 comprises a gyroscopic sensor arranged to measure orientation of the aerogical sonde 20, 24, 27.

The gyroscopic sensor is arranged to measure changes in orientation of the aerogical sonde 20, 24, 27 or angular velocity of the aerogical sonde 20, 24, 27 in relation to at least one rotation axis X, Y or Z of the aerogical sonde 20, 24, 27. Thus, the gyroscopic sensor may measure spinning or turning of the aerogical sonde 20, 24, 27 in the cyclonic storm due to the turbulent streams or turbulent flows in the cyclonic storm.

In one embodiment, the gyroscopic sensor is a multi-dimensional gyroscopic sensor. In this embodiment, the gyroscopic sensor is constructed and arranged to measure orientation or angular velocity of the aerogical sonde 20, 24, 27 in relation to two or more rotation axes, or three rotation axes X, Y and Z. The multi-dimensional gyroscopic sensor has a good effective weight as the one component is able to measure turbulence in the cyclonic storm and spinning of the aerogical sonde 20, 24, 27 around two or more rotation axes X, Y and Z.

In another embodiment, the gyroscopic sensor is a 3-dimensional gyroscopic sensor. In this embodiment, the gyroscopic sensor is constructed and arranged to measure orientation or angular velocity of the aerogical sonde 20, 24, 27. in relation to three rotation axes X, Y and Z. Preferably, the three rotation axes X, Y and Z extend perpendicularly to each other.

Alternatively, the gyroscopic sensor comprises one or more one-dimensional gyroscopic sensors. In this embodiment, the turbulence sensor 70 comprises one or more separate one-dimensional gyroscopic sensors each of which is constructed and arranged to measure orientation or angular velocity of the aerogical sonde 20, 24, 27 in relation to one rotation axis.

In some embodiments, the gyroscopic sensor is a vibrating structure gyroscopic sensor.

In some embodiments, the vibrating gyroscopic sensor may be a microelectromechanical gyroscopic sensor, MEMS gyroscopic sensor.

In one embodiment, the turbulence sensor 70 comprises an accelerometer arranged to measure change of rate of velocity of the self-sustaining aerogical sonde 20, 24, 27. The accelerometer measures changes in moving velocity of the aerogical sonde 20, 24, 27.

In one embodiment, the accelerometer is a multi-dimensional accelerometer. In this embodiment, the accelerometer is constructed and arranged to measure acceleration of the aerogical sonde 20, 24, 27 in direction of two or more velocity axes X, Y and Z. Preferably, the two or more velocity axes X, Y and Z extend perpendicularly to each other.

In another embodiment, the accelerometer is a 3-dimensional accelerometer. In this embodiment, the accelerometer is constructed and arranged to measure changes in movement velocity of the aerogical sonde 20, 24, 27 in relation to three velocity axes X, Y and Z. Preferably, the three velocity axes X, Y and Z extend perpendicularly to each other.

In a further embodiment, the accelerometer comprises one or more one-dimensional accelerometers. In this embodiment, the accelerometer comprises one or more separate one-dimensional accelerometers each of which is constructed and arranged to measure change of velocity of the aerogical sonde 20, 24, 27 in direction of one velocity axis X, Y or Z.

In some embodiments, the accelerometer is a microelectromechanical accelerometer, MEMS accelerometer.

The accelerometer provides acceleration measurement values which may further be used for calculating jerk and jounce. Jerk is the change of rate of acceleration and jounce is change of rate of jerk.

Preferably, the gyroscopic sensor and the accelerometer are provided as a single component. This provides light weight and efficient utilization of space in the aerogical sonde 20, 24, 27.

In another embodiment, the gyroscopic sensor and the accelerometer are provided as separate components.

In one embodiment, the turbulence sensor, or the accelerometer and/or gyroscopic sensor thereof, is secured to the aerogical sonde 20, 24, 27. The turbulence sensor, or the accelerometer and/or gyroscopic sensor thereof, may be provided to the circuit board 30 and the circuit board 30 is secured or attached to the to the structure or casing of the aerological sonde 20, 24, 27.

The measurement unit 12 further comprises a telemetry module 33 configured to transmit measurement data from the aerological sonde 20, 24, 27.

The telemetry module 33 comprises a telemetry element 31. The telemetry element 31 is arranged to transmit measurement data from the aerological sonde 20, 24, 27 to a remote location or system such as base station. Thus, in some embodiments the telemetry element 31 is arranged to transmit measurement data of a turbulence sensor and/or meteorological measurement element and well as signal data of the global navigation satellite system signals.

In some embodiments, the telemetry element 31 is a wireless transmitter element 31 configured to transmit measurement data from the aerological sonde 20, 24, 27.

In some embodiments, the telemetry element 31 is a frequency modulation (FM) element 31 comprising FM link and FM transmitter. An FM antenna 32 is connected to the FM element 31.

The FM antenna 32 is provided to the circuit board 30 or to the flexible circuit board 30 as circuit board antenna.

The FM antenna 32 may be a folded dipole antenna provided to the circuit board 30.

Alternatively, the FM antenna 32 may be a wire antenna.

In some other embodiments, the telemetry element 31 is a wireless communication network element 31, such as Wi-Fi element for cellular network element, or a low-power wide area network element, configured to transmit measurement data from the aerological sonde 20, 24, 27.

In some embodiments, the telemetry module 33 may comprise both the FM transmitter element and the wireless communication network element.

The circuit board antenna 32 may be a folded dipole antenna or the wire antenna and they are preferable due to their light-weight structure.

The above disclosed concerning the aerological sonde 20, 24, 27 and the different embodiments thereof may be used in any combination in the aerological sonde according to the present invention.

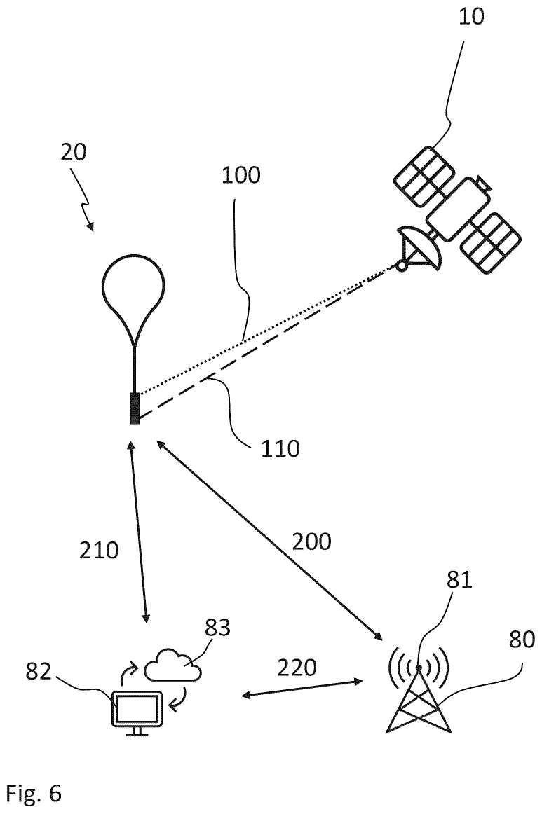

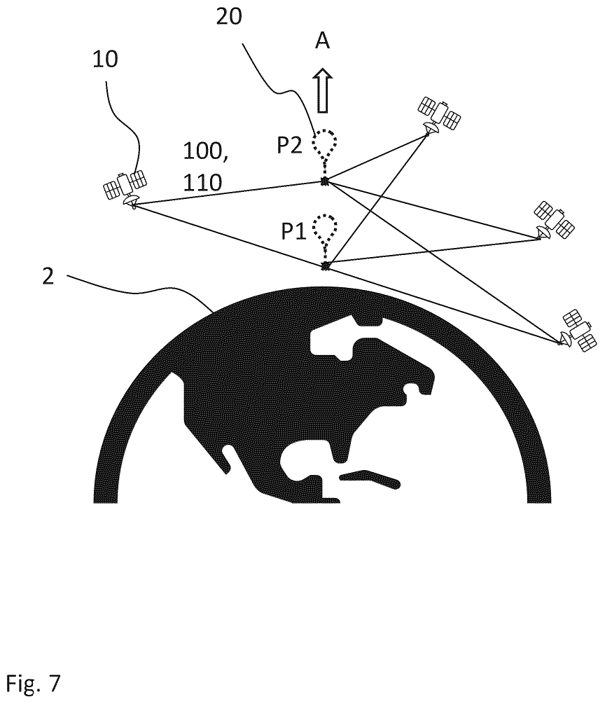

FIG. 6 shows schematically a system according to the present invention. The system comprises one or more aerological sondes 20, 24, 27. The one or more aerological sondes 20, 24, 27 are configured to travel in the atmosphere and receive global navigation satellite system signals 100, 110 from global navigation satellites 10 with the satellite system module 39. According to the present invention the satellite system module 39 is arranged to receive global navigation satellite system signals 100, 110 from the global navigation satellites 10 in at least two different frequencies. Thus, the aerological sonde is arranged to receive at least two global navigation satellite system signals 100, 110 from each of the global navigation satellites 10, the at least two global navigation satellite system signals 100, 110 having different frequencies.

The telemetry module 33 of the aerological sonde 20, 24, 27 is configured to transmit measurement data and signal data 200, 210 of the global navigation satellite system signals 100, 110 from the aerological sonde 20, 24, 27 one or more base stations 80, 82.

The base stations 80, 82 comprise a communication module 81, 83 configured to receive the measurement data and signal data from the one or more aerological sondes 20, 24, 27.

In FIG. 6, the base station 80 is ground station 80. The communication module 81 of the ground station 80 may comprise a base station global navigation satellite system receiver configured to receive global navigation satellite system signals 100, 110 from global navigation satellites 10.

The communication module 81 of the ground station 80 further comprises an FM receiver configured to receive measurement data from the one or more aerological sondes 20, 24, 27.

Alternatively, or additionally, the communication module 81 of the ground station 80 comprises a wireless communication network element such as Wi-Fi element for cellular network element, or a low-power wide area network element, to receive measurement data of the one or more aerological sondes 20, 24, 27.

In addition to or instead of the ground station 80 the system may also comprise virtual base station 82 which may be server system, server or cloud server. The virtual base station 82 may comprise similar communication module 83 as the ground station 80 for receiving measurement data and/or signal data 210 from the aerological sonde 20 or receiving or exchanging data 220 with the ground station 80.

The system may further comprise a processing unit configured to calculate the humidity, temperature and/or pressure based on signal delays in the atmosphere by utilizing the at least two different frequencies of the received global navigation satellite system signals 100, 110.

The processing unit may be provided to the aerological sonde 20, to the ground station 80 or to the virtual base station 82. The processing unit comprises one or more processors, memory unit and instructions for carrying out the calculations.

FIG. 7 shows one embodiment of the present invention in which the aerological sonde is a radiosonde 20. The method comprises receiving the global navigation satellite system signals 100, 110 during ascent of the radiosonde 20 from each of the available satellites 10. The radiosonde 20 ascents in direction of arrow A and is shown schematically in two locations P1 and P2 during the ascent.

Preferably, the method comprises receiving the global navigation satellite system signals 100, 110 during ascent of the radiosonde 20 from two or more satellites 10, as shown in FIG. 7. The radiosonde 20 is configured to receive at least two different global navigation satellite system signals 100, 110 from each satellite 10. Each of the two or more global navigation satellite system signals 100, 110 having a different frequency. Therefore, the radiosonde 20 receives global navigation satellite system signals 100, 110 from several directions in at least two different frequencies. This allows calculation of the signal delay and further the amount of water vapor in the atmosphere in several directions from the radiosonde 20. As this is carried out continuously during the ascent a three-dimensional humidity distribution may be calculated from the aerological sonde 20.

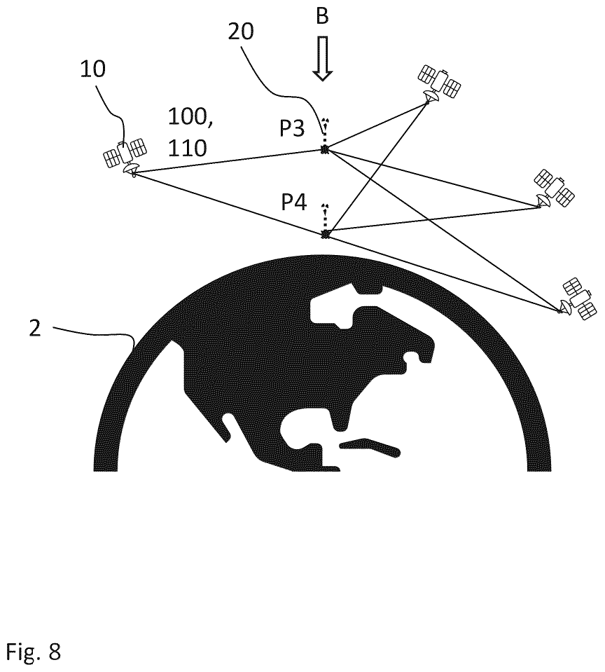

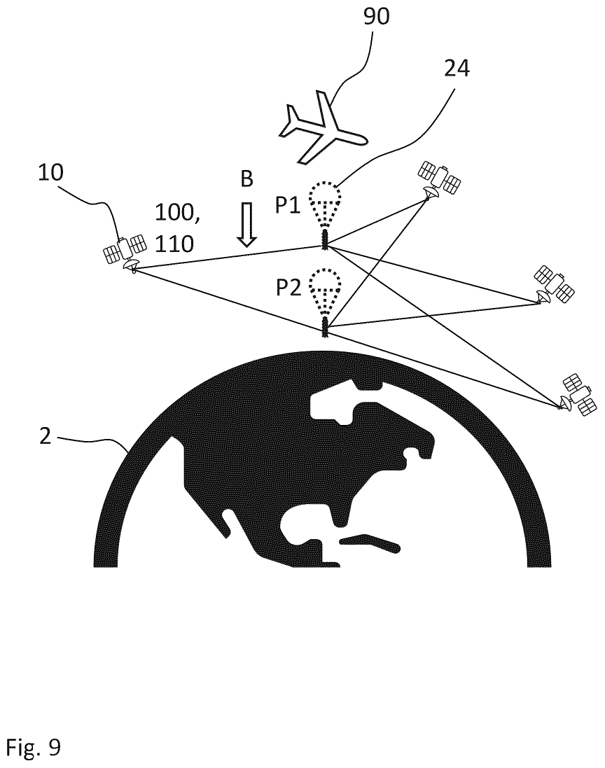

FIG. 8 shows descent of the radiosonde 20 in direction of the arrow B in the atmosphere and between locations P3 and P4. Accordingly, the method comprises receiving the global navigation satellite system signals 100, 110 during descent of the radiosonde 20 from two or more satellites 10, as shown in FIG. 8. The radiosonde 20 is configured to receive at least two different global navigation satellite system signals 100, 110 from each satellite 10. Each of the two or more global navigation satellite system signals 100, 110 having a different frequency. This allows calculation of the signal delay and further the amount of water vapor in the atmosphere in several directions from the radiosonde 20 also during the descent o the radiosonde 20 further calculating the three-dimensional humidity distribution.

In the embodiment of FIG. 9, the aerological sonde is a dropsonde 24. The dropsonde is dropped from the airplane 90, UAV, drone, balloon, or the like at an elevated altitude and let descent towards the ground of the earth. The method comprises receiving the global navigation satellite system signals 100, 110 during descent of the dropsonde 24 from each of the available satellites 10. The dropsonde 24 descent in direction of arrow B and is shown schematically in two locations P1 and P2 during the ascent.

Preferably, the method comprises receiving the global navigation satellite system signals 100, 110 during descent of the dropsonde 24 from two or more satellites 10 simultaneously, as shown in FIG. 9. The dropsonde 24 is configured to receive at least two different global navigation satellite system signals 100, 110 from each satellite 10. Each of the two or more global navigation satellite system signals 100, 110 having a different frequency. Therefore, the dropsonde 24 receives global navigation satellite system signals 100, 110 from several directions in at least two different frequencies. This allows calculation of the signal delay and further the amount of water vapor in the atmosphere in several direction from the dropsonde 24. As this is carried out continuously during the descent a three-dimensional humidity distribution may be calculated from the dropsonde 24.

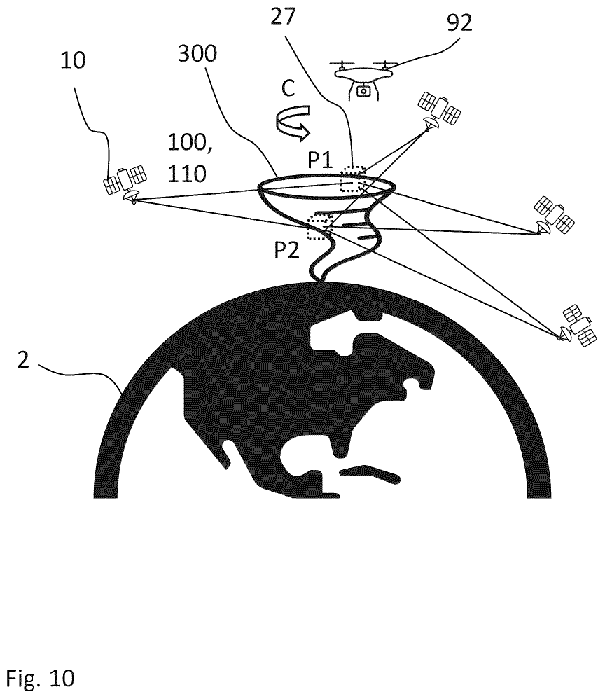

FIG. 10 shows an embodiment in which the aerological sonde is a self-sustaining aerological sonde 27. The self-sustaining aerological sonde 27 is dropped from an unmanned aerial vehicle 92 or the like, such as from an airplane, balloon or other airborne vehicle or system, at an elevated altitude and let travel or migrate in the atmosphere or in a cyclonic storm 300. The method comprises receiving the global navigation satellite system signals 100, 110 during migration of the self-sustaining aerological sonde 27 from each of the available satellites 10. The self-sustaining aerological sonde 27 migration is shown with arrow C and schematically in two locations P1 and P2 during the migration in the cyclonic storm 300.

Preferably, the method comprises receiving the global navigation satellite system signals 100, 110 during migration of the self-sustaining aerological sonde 27 from two or more satellites 10 simultaneously, as shown in FIG. 10. The self-sustaining aerological sonde 27 is configured to receive at least two different global navigation satellite system signals 100, 110 from each satellite 10. Each of the two or more global navigation satellite system signals 100, 110 having a different frequency. Therefore, the self-sustaining aerological sonde 27 receives global navigation satellite system signals 100, 110 from several directions in at least two different frequencies. This allows calculation of the signal delay and further the amount of water vapor in the atmosphere in several direction from the self-sustaining aerological sonde 27. As this is carried out continuously during the migration, a three-dimensional humidity distribution may be calculated from the stream self-sustaining aerological sonde 27.

In all the embodiments described above, temperature and pressure in different directions may be calculated if enough high-quality data is obtained.

The invention has been described above with reference to the examples shown in the figures. However, the invention is in no way restricted to the above examples but may vary within the scope of the claims.

1.-22. (canceled)

23. An aerological sonde for measuring meteorological conditions in atmosphere, the aerological sonde being configured to travel in the atmosphere and comprising a measurement unit having a navigation satellite system module arranged to receive navigation satellite system signals from navigation satellites of a navigation satellite system as measurement data, wherein the navigation satellite system module is configured to receive navigation satellite system signals from navigation satellites of the navigation satellite system on at least two different frequencies.

24. The aerological sonde according to claim 23, wherein the navigation satellite system module comprises:
a first navigation satellite system receiver configured to receive navigation satellite system signals having a first frequency from the navigation satellites of the navigation satellite system, and
a second navigation satellite system receiver configured to receive navigation satellite system signals having a second frequency from the navigation satellites of the navigation satellite system; or
a dual-frequency navigation satellite system receiver configured to receive navigation satellite system signals having a first frequency and navigation satellite system signals having a second frequency from the navigation satellites of the navigation satellite system.

25. The aerological sonde according to claim 23, wherein the navigation satellite system module comprises:
a third navigation satellite system receiver configured to receive navigation satellite system signals having a third frequency from the navigation satellites of the navigation satellite system; or
a multi-frequency navigation satellite system receiver configured to receive navigation satellite system signals having different frequencies from the navigation satellites of the navigation satellite system.

26. The aerological sonde according to claim 23, wherein the aerological sonde comprises the dual-frequency navigation satellite system receiver or the multi-frequency navigation satellite system receiver configured to measure carrier phase data based on the two or more different frequencies.

27. The aerological sonde according to claim 23, wherein:
the navigation satellite system module is configured to receive navigation satellite system signals from two or more navigation satellites of the navigation satellite system; or
the navigation satellite system module is configured to receive navigation satellite system signals from two or more navigation satellites of two or more different navigation satellite systems.

28. The aerological sonde according to claim 23, wherein at least one of:
the navigation satellite system is a global navigation satellite system, the navigation satellite system module is configured to receive global navigation satellite system signals;
the navigation satellite system is a regional navigation satellite system, the navigation satellite system module is configured to receive regional navigation satellite system signals;
the navigation satellite system is a GPS, the navigation satellite system module is configured to receive GPS signals;
the navigation satellite system is a Glonass system, the navigation satellite system module is configured to receive Glonass system signals;
the navigation satellite system is a BeiDou system, the navigation satellite system module is configured to receive BeiDou system signals;
the navigation satellite system is a Galileo system, the navigation satellite system module is configured to receive Galileo system signals;
the navigation satellite system is a QZSS system, the navigation satellite system module is configured to receive QZSS system signals; or
the navigation satellite system is stationary navigation satellite system, the navigation satellite system module is configured to receive stationary navigation satellite system signals.

29. The aerological sonde according to claim 23, wherein at least one of:
the measurement unit of the aerological sonde comprises a turbulence sensor arranged to measure turbulence in the atmosphere;
the measurement unit of the aerological sonde comprises a turbulence sensor arranged to measure turbulence in the atmosphere, the turbulence sensor comprising a gyroscopic sensor arranged to measure change of orientation of the aerological sonde;
the measurement unit of the aerological sonde comprises a turbulence sensor arranged to measure turbulence in the atmosphere, the turbulence sensor comprising an accelerometer arranged to measure change of rate of velocity of the self-sustaining aerological sonde; or
the measurement unit of the aerological sonde comprises a turbulence sensor arranged to measure turbulence in the atmosphere, the turbulence sensor comprising a gyroscopic sensor arranged to measure change of orientation of the aerological sonde and an accelerometer arranged to measure change of rate of velocity of the self-sustaining aerological sonde.

30. The aerological sonde according to claim 23, wherein the measurement unit comprises at least one of:
a telemetry module configured to transmit measurement data from the aerological sonde;
a telemetry module, the telemetry module comprising a wireless transmitter element configured to transmit measurement data from the aerological sonde;
a telemetry module, the telemetry module comprising an FM transmitter element configured to transmit measurement data from the aerological sonde; or
a telemetry module, the telemetry module comprising a wireless communication network element configured to transmit measurement data from the aerological sonde.

31. A system for measuring meteorological conditions in atmosphere, the system comprising:
one or more aerological sondes, the one or more aerological sondes being configured to travel in the atmosphere and comprising a measurement unit having a navigation satellite system module arranged to receive navigation satellite system signals from navigation satellites of a navigation satellite system as measurement data and a telemetry module configured to transmit measurement data from the aerological sonde; and
at least one base station, the at least one base station comprising a communication module configured to receive the measurement data from the one or more aerological sondes, wherein the navigation satellite system module of the one or more aerological sondes is configured to receive navigation satellite system signals from navigation satellites of the navigation satellite system in at least two different frequencies.

32. The system according to claim 31, wherein the navigation satellite system module comprises:
a first navigation satellite system receiver configured to receive navigation satellite system signals having a first frequency from the navigation satellites of the navigation satellite system, and
a second navigation satellite system receiver configured to receive navigation satellite system signals having a second frequency from the navigation satellites of the navigation satellite system; or
a dual-frequency navigation satellite system receiver configured to receive navigation satellite system signals having a first frequency and navigation satellite system signals having a second frequency from the navigation satellites of the navigation satellite system; or
a multi-frequency navigation satellite system receiver configured to receive navigation satellite system signals having different frequencies from the navigation satellites of the navigation satellite system.

33. The system according to claim 31, wherein the telemetry module comprises at least one of:
a wireless transmitter element configured to transmit measurement data from the aerological sonde;
an FM transmitter element configured to transmit measurement data from the aerological sonde; or
a wireless communication network element configured to transmit measurement data from the aerological sonde.

34. The system according to claim 31, wherein at least one of:
the communication module of the base station comprises at least one base station navigation satellite system receiver configured to receive navigation satellite system signals from navigation satellites of the navigation satellite system,
the communication module of the base station comprises an FM receiver configured to receive measurement data from the one or more aerological sondes, and
the communication module of the base station comprises a wireless communication network element to receive measurement data of the one or more aerological sondes.

35. The system according to claim 31, wherein at least one of:
the system comprises a processing unit configured to calculate humidity in the atmosphere by utilizing the at least two different frequencies of the received navigation satellite system signals of the navigation satellite system; or
the system comprises a processing unit configured to calculate humidity, temperature and pressure in the atmosphere by utilizing the at least two different frequencies of the received navigation satellite system signals of the navigation satellite system.

36. The system for measuring meteorological conditions in atmosphere, the system comprising:
one or more aerological sondes, the one or more aerological sondes being configured to travel in the atmosphere and comprising a measurement unit having a navigation satellite system module arranged to receive navigation satellite system signals from navigation satellites of a navigation satellite system as measurement data and a telemetry module configured to transmit measurement data from the aerological sonde; and
at least one base station, the at least one base station comprising a communication module configured to receive the measurement data from the one or more aerological sondes,
wherein the navigation satellite system module of the one or more aerological sondes is configured to receive navigation satellite system signals from navigation satellites of the navigation satellite system in at least two different frequencies, wherein the aerological sonde is an aerological sonde according to claim 23.

37. A method for measuring meteorological conditions in atmosphere, the method comprising:
releasing an aerological sonde to the atmosphere and allowing the aerological sonde to travel in the atmosphere, and
receiving in the aerological sonde navigation satellite system signals from navigation satellites of a navigation satellite system as measurement data during the travel of the aerological sonde in the atmosphere, wherein the method comprises receiving navigation satellite system signals from navigation satellites of the navigation satellite system during the travel of the aerological sonde in the atmosphere on least two different frequencies.

38. The method according to claim 37, further comprising:
receiving at least two navigation satellite system signals from two or more navigation satellites of the navigation satellite system simultaneously, respectively, and the at least two navigation satellite system signals having different frequencies; or
receiving at least two navigation satellite system signals from two or more navigation satellites of two or more different navigation satellite systems, respectively, and the at least two navigation satellite system signals having different frequencies.

39. The method according to claim 37, wherein:
the aerological sonde is a radiosonde comprising an ascent member arranged to lift the radiosonde in the atmosphere, and the method comprises receiving the navigation satellite system signals during ascent of the radiosonde or during descent of the radiosonde or during ascent and descent of the radiosonde in the atmosphere; or
the aerological sonde is a dropsonde comprising a parachute member arranged to slow down dropping of the dropsonde in the atmosphere, and the method comprises receiving the navigation satellite system signals during descent of the dropsonde in the atmosphere; or
the aerological sonde comprises a sonde casing, the sonde casing is arranged to form a sole drag surface of the aerological sonde such that a self-sustaining aerological sonde is formed, and the method comprises receiving the navigation satellite system signals during the travel of the self-sustaining aerological sonde in the atmosphere.

40. The method according to claim 37, further comprising:
calculating the tropospheric delay of the navigation satellite system signals of the navigation satellite system received in the aerological sonde by utilizing the navigation satellite system signals having the at least two different frequencies; or
calculating humidity in the atmosphere by utilizing the navigation satellite system signals of the navigation satellite system having the at least two different frequencies; or
calculating humidity, temperature and pressure in the atmosphere by utilizing the navigation satellite system signals of the navigation satellite system having the at least two different frequencies.

41. The method according to claim 37, further comprising an inversion calculation of a three-dimensional atmospheric model for navigation satellite signals comprising a tropospheric part with humidity, temperature and pressure fields and an ionospheric part comprising a description of the ionosphere by utilizing the at least two frequencies of the received navigation satellite system signals from the two or more navigation satellites of the navigation satellite system during the travel of the aerological sonde in the atmosphere.

42. The method for measuring meteorological conditions in atmosphere, the method comprising:
releasing an aerological sonde to the atmosphere and allowing the aerological sonde to travel in the atmosphere, and
receiving in the aerological sonde navigation satellite system signals from navigation satellites of a navigation satellite system as measurement data during the travel of the aerological sonde in the atmosphere, wherein the method comprises receiving navigation satellite system signals from navigation satellites of the navigation satellite system during the travel of the aerological sonde in the atmosphere on least two different frequencies, wherein the method is carried out with a system for measuring meteorological conditions in atmosphere, the system comprising:
one or more aerological sondes, the one or more aerological sondes being configured to travel in the atmosphere and comprising a measurement unit having a navigation satellite system module arranged to receive navigation satellite system signals from navigation satellites of a navigation satellite system as measurement data and a telemetry module configured to transmit measurement data from the aerological sonde; and
at least one base station, the at least one base station comprising a communication module configured to receive the measurement data from the one or more aerological sondes,
wherein the navigation satellite system module of the one or more aerological sondes is configured to receive navigation satellite system signals from navigation satellites of the navigation satellite system in at least two different frequencies or with an aerological sonde according to claim 23.
